(19) United States
(12) Patent Application Publication
(10) Pub. No.: US 2011/0311953 A1
(43) Pub. Date: Dec. 22, 2011

(54) Apparatus for Converting Feeling Weights into a Representation of Numbers and Mathematical Relationships

(76) Inventor: Karen Goll, Stevensville, MT (US)

(21) Appl. No.: 12/819,031

(22) Filed: Jun. 18, 2010

(51) Int. Cl. G09B 19/02

(52) U.S. Cl. 434/191

(57) ABSTRACT

An apparatus includes a plurality of hand manipulative objects including containers with exteriors having substantially identical textures and colors. Each of the hand manipulative objects has a different weight equivalent to an integer multiple of a first weight. Contents of the containers substantially determine the weights. The weights include a consecutive series of weights including increments of one first weight. A user, manipulating the hand manipulative objects, can discern between different hand manipulative objects, thus enabling the user to convert feeling the weights into a representation of numbers and mathematical relationships.

### FEDERALLY SPONSORED RESEARCH OR DEVELOPMENT

Not applicable.

### REFERENCE TO SEQUENCE LISTING, A TABLE, OR A COMPUTER LISTING APPENDIX

Not applicable.

### COPYRIGHT NOTICE

A portion of the disclosure of this patent document contains material that is subject to copyright protection. The copyright owner has no objection to the facsimile reproduction by anyone of the patent document or patent disclosure as it appears in the Patent and Trademark Office, patent file or records, but otherwise reserves all copyright rights whatsoever.

### FIELD OF THE INVENTION

The present invention relates generally to mathematical manipulatives. More particularly, the invention relates to an educational apparatus which facilitates the teaching of numbers, number sense and how numbers generally relate to one another.

### BACKGROUND OF THE INVENTION

Mathematical manipulatives are objects that can be physically manipulated by a user and are used during the teaching of mathematics. Weighted math manipulatives are commonly used to teach math concepts such as, but not limited to, number sense, addition, subtraction, multiplications, etc. Weighted math manipulatives are regularly paired with a balance scale to enable the meaning of equal to be demonstrated by balancing the scale. The manipulatives in a set are made of the same material; therefore, the weight of the object increases as the size of the object increases, which means students not only see how the weight affects the balance scale, they also see that the objects vary in both size and weight. However, weighted math manipulatives are typically light to human touch, and students are not able to feel the difference in the manipulatives by holding them. This makes typical weighted manipulatives difficult, if not impossible, to use when teaching students who are visually impaired.

In view of the foregoing, there is a need for improved techniques for providing devices for teaching math concepts using manipulatives that enables users to feel the difference in the manipulatives.

### BRIEF DESCRIPTION OF THE DRAWINGS

The present invention is illustrated by way of example, and not by way of limitation, in the figures of the accompanying drawings and in which like reference numerals refer to similar elements and in which:

FIG. 1 is a diagrammatic top view of an exemplary set of number weighted manipulatives, in accordance with an embodiment of the present invention.

Unless otherwise indicated illustrations in the figures are not necessarily drawn to scale.

### SUMMARY OF THE INVENTION

To achieve the forgoing and other objects and in accordance with the purpose of the invention, an apparatus for converting feeling weights into a representation of numbers and mathematical relationships is presented.

In one embodiment an apparatus includes means for enabling the user to convert feeling weights into a representation of numbers and mathematical relationships. Another embodiment further includes means for indicating the weights.

In another embodiment an apparatus includes a plurality of generally similar hand manipulative objects. Each of the hand manipulative objects has a different weight equivalent to an integer multiple of a first weight. A user, manipulating the hand manipulative objects, can discern between different hand manipulative objects, thus enabling the user to convert feeling the weight of each hand manipulative object into a representation of numbers. Another embodiment further includes indicia displayed on the hand manipulative objects for indicating the integer multiple of the hand manipulative object. In still another embodiment, weights of the hand manipulative objects include a consecutive series of weights. In yet another embodiment the consecutive series of weights includes increments of one first weight. Another embodiment further enables the user to convert feeling the weights into mathematical relationships. In yet another embodiment the hand manipulative objects include containers. In still another embodiment, contents of the containers substantially determine the weights. In another embodiment the containers include beanbags. In yet another embodiment the hand manipulative objects include solid forms. In still another embodiment, densities of the solid forms substantially determine the weights. In another embodiment textures of exteriors of the hand manipulative objects are substantially identical. In yet another embodiment, colors of exteriors of the hand manipulative objects are substantially identical. In still another embodiment the first weight is at least 50 grams.

In another embodiment an apparatus includes a plurality of hand manipulative objects including containers with exteriors having substantially identical textures and colors. Each of the hand manipulative objects has a different weight equivalent to an integer multiple of a first weight. Contents of the containers substantially determine the weights. The weights include a consecutive series of weights including increments of one first weight. A user, manipulating the hand manipulative objects, can discern between different hand manipulative objects, thus enabling the user to convert feeling the weights into a representation of numbers and mathematical relationships. Another embodiment further includes indicia displayed on the objects for indicating the integer multiple. In yet another embodiment the contents include a fill material. In still another embodiment the containers include beanbags. In another embodiment the first weight is at least 50 grams.

Other features, advantages, and objects of the present invention will become more apparent and be more readily understood from the following detailed description, which should be read in conjunction with the accompanying drawings.

### DETAILED DESCRIPTION OF THE PREFERRED EMBODIMENTS

The present invention is best understood by reference to the detailed figures and description set forth herein.

Embodiments of the invention are discussed below with reference to the Figures. However, those skilled in the art will readily appreciate that the detailed description given herein with respect to these figures is for explanatory purposes as the invention extends beyond these limited embodiments. For example, it should be appreciated that those skilled in the art will, in light of the teachings of the present invention, recognize a multiplicity of alternate and suitable approaches, depending upon the needs of the particular application, to implement the functionality of any given detail described herein, beyond the particular implementation choices in the following embodiments described and shown. That is, there are numerous modifications and variations of the invention that are too numerous to be listed but that all fit within the scope of the invention. Also, singular words should be read as plural and vice versa and masculine as feminine and vice versa, where appropriate, and alternative embodiments do not necessarily imply that the two are mutually exclusive.

The present invention will now be described in detail with reference to embodiments thereof as illustrated in the accompanying drawings.

Detailed descriptions of the preferred embodiments are provided herein. It is to be understood, however, that the present invention may be embodied in various forms. Therefore, specific details disclosed herein are not to be interpreted as limiting, but rather as a basis for the claims and as a representative basis for teaching one skilled in the art to employ the present invention in virtually any appropriately detailed system, structure or manner.

It is to be understood that any exact measurements/dimensions or particular construction materials indicated herein are solely provided as examples of suitable configurations and are not intended to be limiting in any way. Depending on the needs of the particular application, those skilled in the art will readily recognize, in light of the following teachings, a multiplicity of suitable alternative implementation details.

Preferred embodiments of the present invention provide means using number weighted manipulatives for teaching number representations, mathematical relationships, such as, but not limited to, greater than, less than, equal to, etc., and math facts for educational or therapeutic purposes. The weight of each manipulative in preferred embodiments can be discerned or differentiated by human touch, and each manipulative is weighted by an integer multiple of one, where the lightest manipulative represents one. Also, each manipulative in preferred embodiments is the same size and texture, while the weights vary. This creates the opportunity for students to learn about the representation of numbers by converting the feeling of the weight of each manipulative instead of by seeing the size or frequency of manipulatives. Educators may use manipulatives according to preferred embodiments to teach a wide range of math facts through the sense of touch instead of the sense of sight. Therapists may also use the manipulatives to aide in regenerative cognitive therapy for victims of brain trauma. One desired characteristic of the number weighted manipulatives in preferred embodiments is to provide the opportunity for students to learn about numbers by only being able to rely on their sense of touch to differentiate between numbers and groups of numbers without any secondary visual guidance.

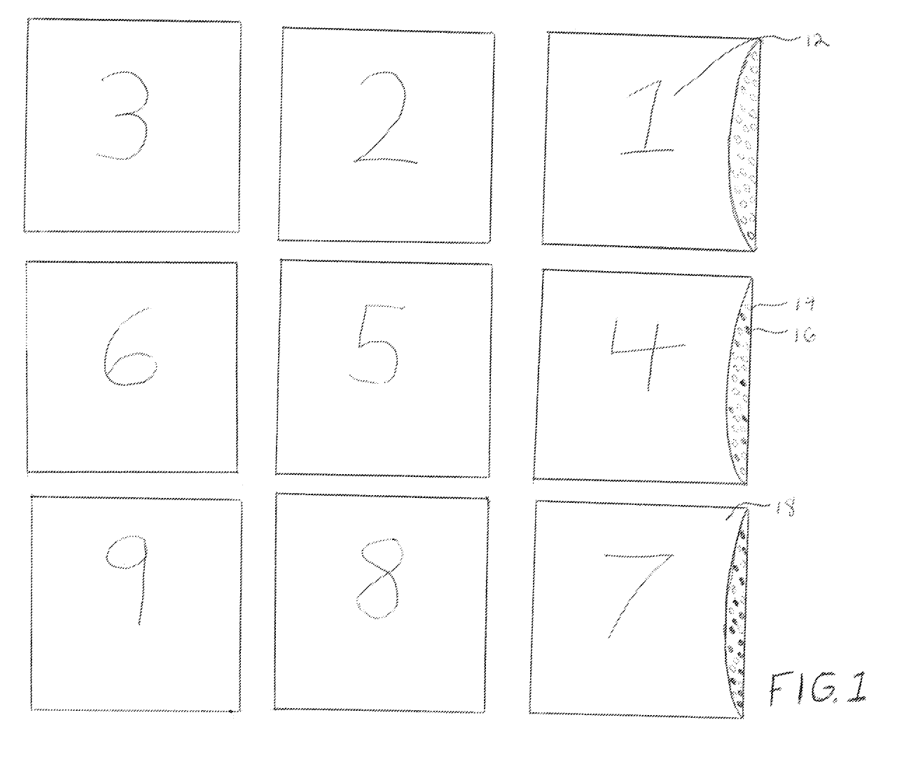

FIG. 1 is a diagrammatic top view of an exemplary set of number weighted manipulatives, in accordance with an embodiment of the present invention. Interior views of the manipulatives numbered 1, 4 and 7 are also shown. In the present embodiment, the manipulatives are square beanbags; however, manipulatives in alternate embodiments may have various different forms such as, but not limited to, beanbags of different shapes, boxes, balls, stuffed animals, etc. In the present embodiment, a beanbag exterior 18 of each manipulative may be made from any material capable of holding a fill material such as, but not limited to, heavy fabric, knitted material, nylon, plastic, etc. In alternate embodiments that are not beanbags, various different types of material may form the exterior of the manipulatives. For example, without limitation, manipulatives in one alternate embodiment may be hard plastic boxes filled with a fill material, and manipulatives in another alternate embodiment may comprise hollow rubber balls as exteriors. The texture of the exterior of all of the manipulatives in the present embodiment is preferably the same.

In the present embodiment, the fill material is a combination of a relatively light material 14 such as, but not limited to, plastic beads, glass beads, wood fiber, cotton, etc. and a relatively heavy material 16 such as, but not limited to, steel balls, copper balls, other types of metallic filler, ceramic beads, etc. Different combinations of light fill material 14 and heavy fill material 16 are used to create various manipulatives of the same size and texture with different weights. Referring to FIG. 1, the manipulatives numbered 1, 4 and 7 illustrate that the amount of heavy fill material 16 increases as the number represented by the manipulative increases. Therefore, the manipulative numbered 7 comprises more heavy fill material 16 than the manipulative numbered 4, and the manipulative numbered 4 comprises more heavy fill material 16 than the manipulative numbered 1. Light fill material 14 is used to fill the extra space in the manipulatives that have less heavy fill material 16 so all of the manipulatives are roughly the same size. Therefore, manipulatives representing lower numbers have more light fill material 14 than manipulatives representing higher numbers. The fill material can be a combination of any number of materials in so much as these materials can be combined in different ratios to create fill materials that are of equal mass and varying density to create same-sized manipulatives with weights varying by equal multiples.

In the present embodiment, each manipulative weighs a multiple of manipulative one. The multiple of the weight for each manipulative is designated by a number 12 on the front of the manipulative. FIG. 1 shows manipulatives numbered one through nine, although manipulatives may be made for higher numbers as long as each manipulative is a multiple of one. In the present embodiment, the manipulatives form a consecutive series of weights having increments of one weight. In the present embodiment, each manipulative is preferably the same size and shape. Each manipulative is also preferably the same color. The only distinguishing visual feature between the manipulatives is number 12 on the front of the manipulative. Should number 12 be removed, the manipulatives are virtually indistinguishable by sight and can only be differentiated once held or put on a scale. Alternate embodiments may be implemented that may be differentiated visually as well as by touch. In other alternate embodiments, each manipulative may have a unique shape, color or both.

In the present embodiment, the number weighted manipulatives may be sized according to use as an educational manipulative set, and young children should be able to handle each manipulative. Each manipulative weighs enough so that the difference in weight can be determined by holding and comparing each manipulative. A person should be able to order the manipulatives from lightest to heaviest with relatively good accuracy. In the present embodiment, the lightest manipulative preferably weighs at least 50 grams. When the lightest manipulative weighs 50 grams, all other manipulatives increase in weight by 50 grams at each increment. Those skilled in the art, in light of the present teachings, will readily recognize that the weight increments in alternate embodiments may vary and that the lightest manipulative may weigh more or less than 50 grams.

Alternate embodiments of the present invention may implement manipulatives comprising solid forms such as, but not limited to, blocks or solid balls rather than hollow forms with fill material. These embodiments may be made of different materials with different densities, such as, but not limited to, various types of metals, to enable manipulatives of the same size to have different weights. Alternatively, manipulatives in these embodiments may have cores of different materials with varying density inside the same external material to generally ensure that the manipulatives look alike.

Other alternate embodiments may comprise means for producing sound. In these embodiments, each manipulative is able to announce the number that it is representing. Some of these embodiments may also comprise a sensor that prompts the manipulative to make this announcement when the manipulative is picked up, squeezed or placed on a scale.

Having fully described at least one embodiment of the present invention, other equivalent or alternative methods of providing mathematical manipulatives according to the present invention will be apparent to those skilled in the art. The invention has been described above by way of illustration, and the specific embodiments disclosed are not intended to limit the invention to the particular forms disclosed. For example, the particular implementation of the manipulatives may vary depending upon the particular type of numerical range being represented. The manipulatives described in the foregoing were directed to implementations representing numerical ranges of consecutive whole numbers; however, similar techniques are to provide manipulatives to represent different numerical ranges such as, but not limited to, fractions between 0 and 1, odd numbers, even numbers, multiples of 5, etc. Implementations of the present invention not representing consecutive whole numbers are contemplated as within the scope of the present invention. The invention is thus to cover all modifications, equivalents, and alternatives falling within the spirit and scope of the following claims.

Claim elements and steps herein have been numbered and/or lettered solely as an aid in readability and understanding. As such, the numbering and lettering in itself is not intended to and should not be taken to indicate the ordering of elements and/or steps in the claims.

What is claimed is:

1. An apparatus comprising:
means for enabling a user to convert feeling weights into a representation of numbers and mathematical relationships.

2. The apparatus as recited in claim 1, further comprising means for indicating said weights.

3. An apparatus comprising:
a plurality of generally similar hand manipulative objects, each of said hand manipulative objects having a different weight equivalent to an integer multiple of a first weight, wherein a user, manipulating said hand manipulative objects, can discern between different hand manipulative objects, thus enabling the user to convert feeling said weight of each hand manipulative object into a representation of numbers.

4. The apparatus as recited in claim 3, further comprising indicia displayed on said hand manipulative objects for indicating said integer multiple of said hand manipulative object.

5. The apparatus as recited in claim 3, wherein weights of said hand manipulative objects comprise a consecutive series of weights.

6. The apparatus as recited in claim 5, wherein said consecutive series of weights comprises increments of one first weight.

7. The apparatus as recited in claim 3, further enabling the user to convert feeling said weights into mathematical relationships.

8. The apparatus as recited in claim 3, wherein said hand manipulative objects comprise containers.

9. The apparatus as recited in claim 8, wherein contents of said containers substantially determine said weights.

10. The apparatus as recited in claim 8, wherein said containers comprise beanbags.

11. The apparatus as recited in claim 3, wherein said hand manipulative objects comprise solid forms.

12. The apparatus as recited in claim 11, wherein densities of said solid forms substantially determine said weights.

13. The apparatus as recited in claim 3, wherein textures of exteriors of said hand manipulative objects are substantially identical.

14. The apparatus as recited in claim 3, wherein colors of exteriors of said hand manipulative objects are substantially identical.

15. The apparatus as recited in claim 3, wherein said first weight is at least 50 grams.

16. An apparatus comprising:
a plurality of hand manipulative objects comprising containers with exteriors having substantially identical textures and colors, each of said hand manipulative objects having a different weight equivalent to an integer multiple of a first weight, where contents of said containers substantially determine said weights, and said weights comprise a consecutive series of weights comprising increments of one first weight, wherein a user, manipulating said hand manipulative objects, can discern between different hand manipulative objects, thus enabling the user to convert feeling said weights into a representation of numbers and mathematical relationships.

17. The apparatus as recited in claim 16, further comprising indicia displayed on said objects for indicating said integer multiple.

18. The apparatus as recited in claim 16, wherein said contents comprise a fill material.

19. The apparatus as recited in claim 16, wherein said containers comprise beanbags.

20. The apparatus as recited in claim 16, wherein said first weight is at least 50 grams.
